(19) United States
(12) Patent Application Publication
(10) Pub. No.: US 2023/0028394 A1
(43) Pub. Date: Jan. 26, 2023

(54) CODE-BASED MALWARE DETECTION

(71) Applicant: British Telecommunications Public Limited Company, London (GB)

(72) Inventor: Fadi EL-MOUSSA, London (GB)

(21) Appl. No.: 17/758,371

(22) PCT Filed: Dec. 18, 2020
(86) PCT No.: PCT/EP2020/087117

§ 371 Date: Jul. 5, 2022

(30) Foreign Application Priority Data
Jan. 5, 2020 (EP) 20150296.0

(51) Int. Cl. G06F 21/56

(52) U.S. Cl. CPC G06F 21/56; G06F 2221/034

(57) ABSTRACT

A computer implemented method of detecting malware in a received software component includes generating a profile for the malware by accessing machine code for the malware, identifying a subset of the machine code for the malware as a logical subroutine of the malware, and extracting one or more features of the logical subroutine of the malware as the profile. The method further includes accessing machine code for the received software component to identify a plurality of logical subroutines thereof and extracting one or more features of each logical subroutine of the received software component for comparison with the profile to detect the malware in the received software component.

### PRIORITY CLAIM

The present application is a National Phase entry of PCT Application No. PCT/EP/2020/087117 filed, Dec. 18, 2020, which claims priority from EP Patent Application No. 20150296.0, filed Jan. 5, 2020, which is hereby fully incorporated herein by reference.

### TECHNICAL FIELD

The present disclosure relates to the detection of malicious software code.

### BACKGROUND

Traditional malware detection is based on the generation of signatures of malware code such as by hashing of all or part of known malware to provide a suitable and efficient basis for comparison at malware scanning time. This suffers from missed detection due to minor changes to malware—a single bit change in a malware can result in an entirely different signature and non-detection. Existing approaches to address this challenge can involve modularizing malware into smaller components for which signatures are generated such that a granularity of signature generation can be finer. This permits detection of malware where there is wholesale identity within any particular module in dependence on module size, though malware adapts to include minor adjustments throughout the content of the malware to undermine any such granular signature generation.

Accordingly, it is beneficial to provide improvements in the detection of malware.

### SUMMARY

According to a first aspect of the present disclosure, there is provided a computer implemented method of detecting malware in a received software component comprising: generating a profile for the malware by: a) accessing machine code for the malware; b) identifying a subset of the machine code for the malware as a logical subroutine of the malware; c) extracting one or more features of the logical subroutine of the malware as the profile, accessing machine code for the received software component to identify a plurality of logical subroutines thereof; extracting one or more features of each logical subroutine of the received software component for comparison with the profile to detect the malware in the received software component.

In some embodiments, a feature of a logical subroutine includes one or more of: a number of processor registers used in the logical subroutine; an identification of registers used in the logical subroutine; a stack size used in the logical subroutine; a location or range of locations of a memory region accessed in the logical subroutine; and an identification of one or more operating system application programming interface calls in the logical subroutine.

In some embodiments, identifying a logical subroutine in machine code includes one or more of: identifying a series of machine code instructions accessed via a jump, branch or conditional machine code instruction; identifying a series of machine code instructions collocated in the machine code; identifying a series of machine code instructions collocated in the machine code and bounded by subroutine identifiers; and executing the machine code and monitoring the execution to trace execution paths through the machine code wherein a repeated series of machine code instructions within an execution path is determined to correspond to a logical subroutine of the machine code.

In some embodiments, identifying a logical subroutine in machine code includes disassembling the machine code to an assembler language representation of the machine code.

In some embodiments, detection of the malware in the received software component is based on identity of one or more of: a number of registers used in the logical subroutine of each of the received software component and the malware; a stack size used in the logical subroutine of each of the received software component and the malware; a location or range of locations of a memory region accessed in the logical subroutine of each of the received software component and the malware; and an identification of one or more operating system application programming interface calls in the logical subroutine of each of the received software component and the malware.

In some embodiments, detection of the malware in the received software component is based on score determined by the comparison in which the score is based on a degree of similarity of any or all of: a number of registers used in the logical subroutine of each of the received software component and the malware; a stack size used in the logical subroutine of each of the received software component and the malware; a location or range of locations of a memory region accessed in the logical subroutine of each of the received software component and the malware; and an identification of one or more operating system application programming interface calls in the logical subroutine of each of the received software component and the malware.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement for detecting malware in a received software component in accordance with embodiments of the present disclosure.

FIG. 3 is a flowchart of a method for detecting malware in a received software component in accordance with embodiments of the present disclosure.

### DETAILED DESCRIPTION

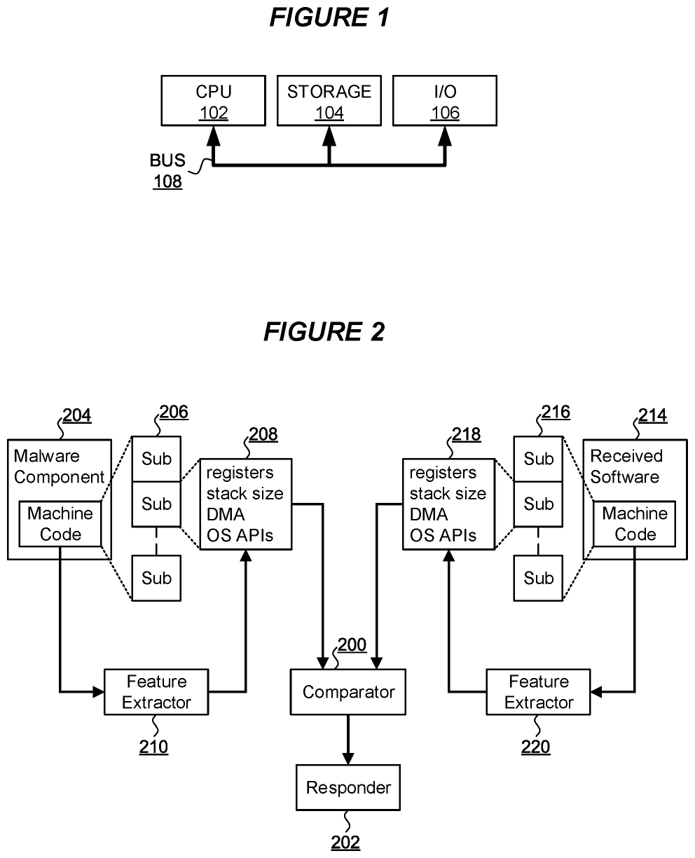

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an arrangement for detecting malware in a received software component in accordance with embodiments of the present disclosure. A malware component 204 as an executable software component including executable machine code is processed to generate a profile 208 for the malware 204 as one or more data structure representations of features of the malware. In particular, the profile 208 corresponds to features of one or more logical subroutines 206 of the malware component 204. A logical subroutine is a subset of machine code comprised in the malware component 204 that comprises one or more sequences of machine code instructions. Each subroutine 206 is identified based on an analysis of the machine code for the malware component 204. Notably, subroutines defined by one or more programmers, or generated by one or more code generators such as a compiler, assembler or the like, are not necessarily the same as, or the whole extent of, the subroutines identified based on the analysis since the analysis according to embodiments of the present disclosure for the identification of the subroutines 206 is performed on executable machine code for the malware component 204 that may not have access to source code, source assembler code or the like. Accordingly, the subroutines identified in accordance with embodiments of the present disclosure are inferred and thus referred to as logical subroutines that may or may not, or may to some extent, correspond to subroutines explicitly created, generated, or programmed in the machine code.

In the embodiment of FIG. 2, a feature extractor 210 is provided as a hardware, software, firmware or combination component arranged to identify a subset of the machine code of the malware component 204 as a logical subroutine of the malware. The feature extractor 210 accesses the machine code for the malware component 204 that may be provided as machine code instructions in, for example, binary or hexadecimal representation, or assembly language instructions in, for example, a textual representation. In one embodiment, the machine code is disassembled by a disassembler computing component as is known in the art, in which case the feature extractor 210 is operable on an assembly language representation of the machine code.

The feature extractor 210 identifies the logical subroutine in the machine code based on, for example, inter alia: an identification of a series of machine code instructions in the code accessed via a jump, branch or conditional machine code instruction; an identification of a series of machine code instructions in the code collocated in the machine code; an identification of a series of machine code instructions collocated in the machine code and bounded by subroutine identifiers, such as identifiers in an assembler language representation of the machine code; and an execution of the machine code and monitoring the execution to trace execution paths through the machine code such that a repeated series of machine code instructions within an execution path is determined to correspond to a logical subroutine of the machine code. Notably, in use, the feature extractor 210 can identify multiple such logical subroutines in which case embodiments of the disclosure as described below can be operable on each or some subset of all identified logical subroutines.

The feature extractor 210 is further operable to extract one or more features of an identified logical subroutine to generate and define a profile 204 for the malware. Features of the logical subroutine can include one or more of, inter alia: a number of processor registers used in the logical subroutine; an identification of registers used in the logical subroutine; a stack size used in the logical subroutine, such as a stack size indicated by a stack size (SS) register or the like; a location or range of locations of a memory region accessed in the logical subroutine, such as by direct memory access (DMA); and an identification of one or more Operating System (OS) Application Programming Interface (API) calls in the logical subroutine, such as OS functions for the allocation, deallocation, reserving or otherwise using memory of a computer system. Such features can be stored in a profile 208 such as a data structure or the like.

In use, software 214 is received or otherwise accessed by a computer system such as software received or downloaded via a network such as the internet, or software stored by a computer system selected for execution by the computer system. Such received software 214 is analyzed in accordance with embodiments of the present disclosure for the identification of all or part of the malware component 204 therein. A feature extractor 220 is provided, which can be one and the same as feature extractor 210, to analyze executable machine code of the received software 214 substantially as hereinbefore described with reference to the analysis of feature extractor 210 of the malware component 204. In particular, the feature extractor 220 identifies a plurality of logical subroutines in the machine code of the received software 214, for example using techniques described above. Further, the feature extractor 220 extracts features of identified logical subroutines in the machine code of the received software 214 as a feature set 218, one such set being provided for each logical subroutine identified in the machine code of the received software 214. Features extracted by the feature extractor 220 are consistent with, and can include a subset of, those features described above with respect the feature extractor 210 operable with the machine code of the malware component 204.

A comparator 200 is provided as a hardware, software, firmware or combination component for comparing the malware profile 208 with the feature set 218 of each identified logical subroutine of the received software 214. Such comparison is suitable for identifying identities or similarities between the profile 208 of the malware 204 and the features 218 of subroutines 216 in the received software 214. In this way, presence of all or part of the malware 204 in the received software 214 can be predicted. The comparison by the comparator 200 can be based on predetermined criteria for the comparator 200 to determine that there is sufficient similarity or identity of features to conclude that malware is present in the received software 214. For example, a minimum number of identical or similar features may be required. In one embodiment, the comparator 200 can operate on the basis of a scoring of similar or identical features such that certain features can be weighted more highly than others with a threshold score being used to determine when sufficient similarity of features is reached to determine a likelihood of presence of malware in the received software 214. For example, the score can be based on a degree of similarity or identity of any or all of, inter alia: a number of registers used in the logical subroutine of each of the received software component 214 and the malware 204; a stack size used in the logical subroutine of each of the received software component 214 and the malware 204; a location or range of locations of a memory region accessed in the logical subroutine of each of the received software component 214 and the malware 204; and an identification of one or more operating system application programming interface calls in the logical subroutine of each of the received software component 214 and the malware 204.

When the comparator 200 determines or predicts a likelihood of malware in the received software 214, a responder component 202 is triggered to provide a responsive action to the malware detection. The responder 202 is a hardware, software, firmware or combination component operable responsive to the comparator 200 to respond to a determination that there is, or there is a likelihood of, malware in the received software 214. The responder can undertake responsive actions such as, inter alia: isolating, quarantining or deleting the received software 214; trigger further scanning of the received software 214; alerting a user as to the existence of the received software 214; dispatch, send or otherwise communicate the received software 214 to a malware reporting, scanning or protection component; utilize the received software 214 as input to train a further, additional or downstream malware detection component; add the received software 214 to a register of detected malware; and other responsive measures as will be apparent to those skilled in the art.

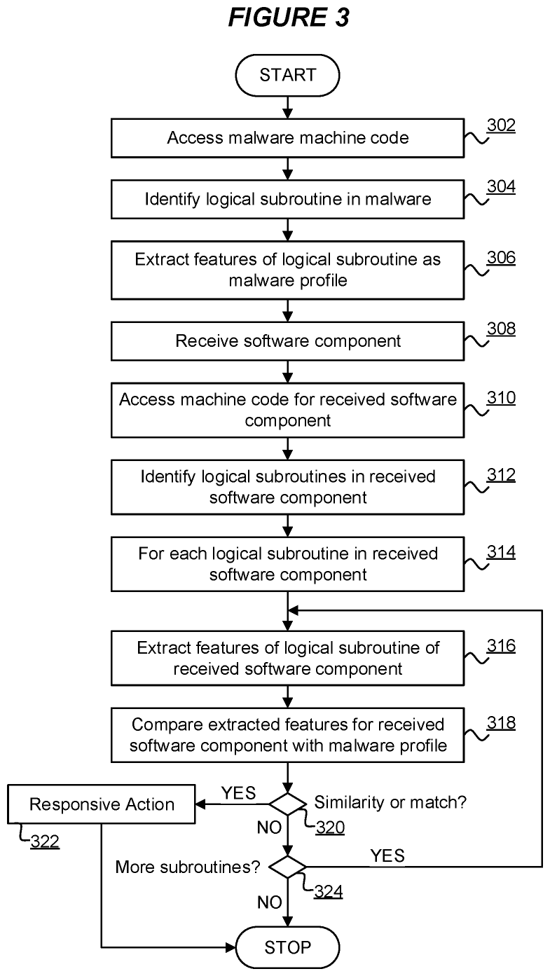

FIG. 3 is a flowchart of a method for detecting malware in a received software component in accordance with embodiments of the present disclosure. Initially, at 302, the method accesses machine code for a malware component 204. At 304 the feature extractor 210 identifies a logical subroutine in the machine code of the malware 204. At 306 the feature extractor 210 extracts features of the logical subroutine for storage as a profile 208. At 308 the method receives or accesses a new software component 214 to be scanned for malware. At 310 the method accesses machine code of the received software component 214 and at 312 the method identifies one or more logical subroutines 216 in the received software component 214. At 314 the method loops through each identified logical subroutine 216 in the received software component 214 and at 316 the method extracts features of a current logical subroutine of the received software component. At 318 the method compares the extracted features of the current logical subroutine with the features of the malware profile 208 and, where these match at 320, responsive action(s) are triggered at 322. The loop through the logical subroutines of the received software 214 is continued at 324.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of detecting malware in a received software component comprising:
generating a profile for the malware by:
a) accessing machine code for the malware;
b) identifying a subset of the machine code for the malware as a logical subroutine of the malware;
c) extracting one or more features of the logical subroutine of the malware as the profile;
accessing machine code for the received software component to identify a plurality of logical subroutines thereof; and
extracting one or more features of each logical subroutine of the received software component for comparison with the profile to detect the malware in the received software component.

2. The method of claim 1 wherein a feature of a logical subroutine includes one or more of: a number of processor registers used in the logical subroutine; an identification of registers used in the logical subroutine; a stack size used in the logical subroutine; a location or a range of locations of a memory region accessed in the logical subroutine; and an identification of one or more operating system application programming interface calls in the logical subroutine.

3. The method of claim 1 wherein identifying a logical subroutine in machine code includes one or more of: identifying a series of machine code instructions accessed via a jump, a branch, or a conditional machine code instruction; identifying a series of machine code instructions collocated in the machine code; identifying a series of machine code instructions collocated in the machine code and bounded by subroutine identifiers; and executing the machine code and monitoring the execution to trace execution paths through the machine code wherein a repeated series of machine code instructions within an execution path is determined to correspond to a logical subroutine of the machine code.

4. The method of claim 1 wherein identifying a logical subroutine in machine code includes disassembling the machine code to an assembler language representation of the machine code.

5. The method of claim 1 wherein detection of the malware in the received software component is based on identifying one or more of: a number of registers used in the logical subroutine of each of the received software component and the malware; a stack size used in the logical subroutine of each of the received software component and the malware; a location ora range of locations of a memory region accessed in the logical subroutine of each of the received software component and the malware; and an identification of one or more operating system application programming interface calls in the logical subroutine of each of the received software component and the malware.

6. The method of claim 1 wherein detection of the malware in the received software component is based on a score determined by the comparison in which the score is based on a degree of similarity of one or more of: a number of registers used in the logical subroutine of each of the received software component and the malware; a stack size used in the logical subroutine of each of the received software component and the malware; a location or a range of locations of a memory region accessed in the logical subroutine of each of the received software component and the malware; and an identification of one or more operating system application programming interface calls in the logical subroutine of each of the received software component and the malware.

7. A computer system including a processor and a memory storing computer program code for performing the method of claim 1.

8. A computer program element comprising computer program code to, when loaded into a computer system and executed thereon, cause the computer to perform the method of claim 1.
